(19) United States
(12) Patent Application Publication
(10) Pub. No.: US 2026/0180063 A1
(43) Pub. Date: Jun. 25, 2026

(54) ELECTRIC DRIVE MACHINE HAVING POWER DISTRIBUTION UNIT CONFIGURED FOR LIMP HOME OPERATION AND METHOD

(71) Applicant: Caterpillar Inc., Peoria, IL (US)

(72) Inventors: MAHESH K. MOKIRE, Dunlap, IL (US); BRADLEY S. BAILEY, Edwards, IL (US); JASON L. MILLER, Princeville, IL (US); JONATHAN M. BAUMANN, Hanna City, IL (US)

(73) Assignee: Caterpillar Inc., Peoria, IL (US)

(21) Appl. No.: 19/127,544

(22) PCT Filed: Oct. 4, 2023
(86) PCT No.: PCT/US2023/075914

§ 371 Date: May 6, 2025

Related U.S. Application Data
(60) Provisional application No. 63/424,338, filed on Nov. 10, 2022.

(51) Int. Cl. H01M 10/625; H01M 10/613

(52) U.S. Cl. CPC H01M 10/625; H01M 10/613

(57) ABSTRACT

An electric drive machine includes an electric drive system structured to operate ground-engaging propulsion elements, a power distribution unit (PDU), and a plurality of electrically powered accessories arranged in a first accessory set and a second accessory set. The PDU includes a first bus electrically connected to plural accessories in the first accessory set and to at least one accessory in the second accessory set, a second bus electrically connected to plural accessories in the second accessory set and to at least one accessory in the first accessory set, a first contactor electrically connected to the first bus, and a second contactor electrically connected to the second bus. The electric drive machine has a full power mode where each of the first contactor and the second contactor in the PDU is ON, and is adjustable to a limp home mode where one of the first contactor or the second contactor is ON and the other of the first contactor or the second contactor is OFF. Related methodology is also disclosed.

### TECHNICAL FIELD

The present disclosure relates generally to operating an electric drive machine, and more particularly to switching an electric drive machine from a full power mode to a limp home mode.

### BACKGROUND

In recent years a variety of industries have begun transitioning from traditional power sources such as fossil fuels to electric power. Fully electric and hybrid vehicles have become commonplace in national transportation infrastructures, for example. Certain other industries now employ electrification to some extent but have yet to realize electric power's full theoretical potential.

In construction, mining, and certain other industries utilizing complex machinery partially electrified machines employing diesel-electric drive systems have experienced commercial success. Fully electrified machinery fleets, notably in the mining context, have been proposed where mining trucks can selectively connect to an external electric power supply, and operate on stored electrical energy when such direct connections are not readily available.

As with any new and emerging technology efforts at electrifying machines have presented a variety of new problems. Fully electric machinery, particularly in complex and heavy-duty machine systems, can be associated with literally thousands of possibilities for short circuits and other fault conditions during service. A standard practice for addressing a faulted electrical system in complex electrified machinery is to shut down operation entirely. Removing a machine from service of course carries costs from reduced productivity. Compounding such problems is that machines can be idled at whatever location a problem occurs or is detected, potentially stranding a machine where inspection and/or service is highly inconvenient. One example of an electric drive machine is known from United States Patent Application Publication No. 20140021898A1 to Hendrickson et al.

### SUMMARY

In one aspect, an electric drive machine includes a frame, and ground-engaging propulsion elements coupled to the frame. The electric drive machine further includes an electric drive system having at least one electric drive motor structured to operate the ground-engaging propulsion elements, a power distribution unit (PDU), and a plurality of electrically powered accessories arranged in a first accessory set and a second accessory set. The PDU includes a first bus electrically connected to plural accessories in the first accessory set and to at least one accessory in the second accessory set, a second bus electrically connected to plural accessories in the second accessory set and to at least one accessory in the first accessory set, a first contactor electrically connected to the first bus, and a second contactor electrically connected to the second bus. The electric drive machine has a full power mode where each of the first contactor and the second contactor in the PDU is ON, and is adjustable to a limp home mode where one of the first contactor or the second contactor is ON and the other of the first contactor or the second contactor is OFF.

In another aspect, a method of operating an electric drive machine includes operating an electric drive machine in a full power mode where each of a first contactor electrically connected to a first bus and a second contactor electrically connected to a second bus in a power distribution unit (PDU) is ON, and supplying electric power from the PDU to plural accessories in a first accessory set and to at least one accessory in a second accessory set via the first bus, and to plural accessories in the second accessory set and to at least one accessory in the first accessory set via the second bus, in the full power mode of the electric drive machine. The method further includes switching the first contactor OFF, operating the electric drive machine in a limp home mode based on the switching the first contactor OFF, and supplying electric power from the PDU to the plural accessories in the second accessory set and to the at least one accessory in the first accessory set via the second bus, in the limp home mode of the electric drive machine.

In still another aspect, an electric drive system for a machine includes a power distribution unit (PDU) including an electric power input, a first switched circuitry, a second switched circuitry, and an unswitched circuitry. The first switched circuitry includes a first bus and a first contactor connected electrically between the first bus and the electric power input, the second switched circuitry includes a second bus and a second contactor connected electrically between the second bus and the electric power input, and the unswitched circuity includes a third bus. The electric drive system further includes a plurality of electrically powered accessories arranged in a first accessory set, a second accessory set, and a third accessory set. The first accessory set includes plural accessories parallel-connected to the first bus, and at least one accessory crossover-connected to the second bus, and the second accessory set includes plural accessories parallel-connected to the second bus, and at least one accessory crossover-connected to the first bus. The PDU is operable in a full power mode where each of the first contactor and the second contactor is ON, and adjustable to operate in a limp home mode where one of the first contactor or the second contactor is ON and the other of the first contactor or the second contactor is OFF.

### BRIEF DESCRIPTION OF THE DRAWINGS

FIG. 1 is a side diagrammatic view of an electric drive machine, according to one embodiment;

FIG. 2 is a schematic illustration of an accessory system for an electric drive system in an electric drive machine, according to one embodiment;

FIG. 3 is a diagrammatic view of a power distribution unit (PDU) for an electric drive system in an electric drive machine, according to one embodiment; and

FIG. 4 is a flowchart illustrating example methodology, according to one embodiment.

### DESCRIPTION

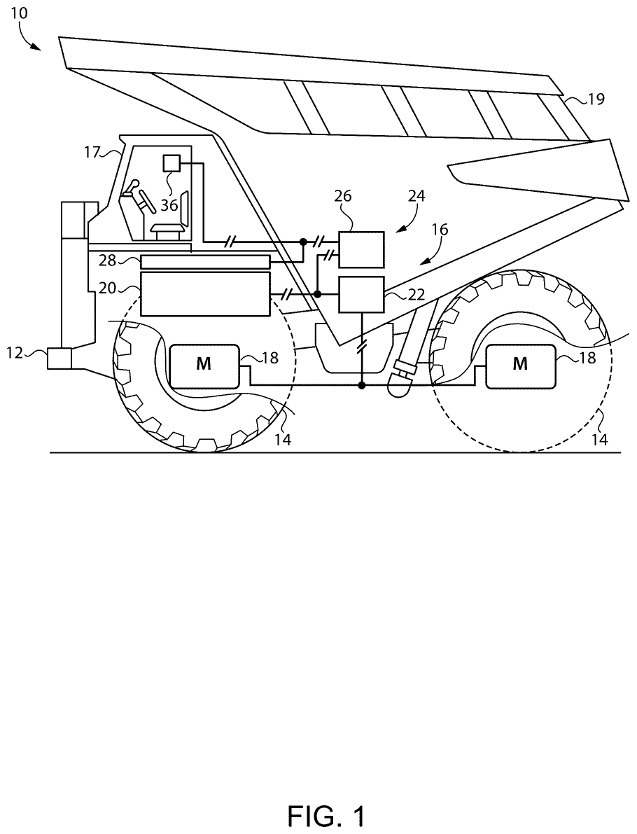

Referring to FIG. 1, there is shown an electric drive machine 10, according to one embodiment. Machine 10 includes a frame 12, ground-engaging propulsion elements 14 coupled to frame 12, and an electric drive system 16. Machine 10 is shown in the context of a mining truck having a dump bed 19 that can be raised and lowered in a generally conventional manner. An operator cab 17 is supported upon frame 12. In the illustrated embodiment, ground-engaging elements 14 are shown as wheels. In other instances, machine 10 might be equipped with ground-engaging tracks or even have a half-track configuration in some instances. Rather than a mining truck, the present disclosure could be implemented in other machines such as tractors, graders, loaders, scrapers, and still others. Electric drive system 16 may include at least one electric drive motor 18 structured to operate ground-engaging propulsion elements 14. Machine 10 is shown configured with individual wheel motors 18. In other embodiments, a single electric drive motor might be provided that operates ground-engaging propulsion elements 14 together, or in a front-wheel drive or a rear-wheel drive arrangement. Electric drive system 16 could also include a transmission coupled between an electric drive motor and some or all of ground-engaging propulsion elements 14. Electric drive machine 10 may be fully electrified and operates electric drive system 16 by way of a battery array or bank 20 including one or more batteries. In addition, to or instead of, electric batteries other electrical energy storage devices such as capacitors might also be used. Electric drive machine 10 could further be configured to charge battery bank 20 by way of plugging into a battery charger while idled or by connecting to an overhead trolley line or an external power rail. Electric drive machine 10 could also include a combustion engine, coupled to an electric generator to provide electric power for propulsion or any other purposes.

As discussed above, electric drive systems can be complex. Particularly in the context of a fully electrified machine the many thousands of electrical connections onboard a machine can create a multitude of opportunities for electrical fault conditions, such as ground faults or other problems. Conventional practice with certain types of machinery when a ground fault or other electrical problem arises anywhere in an electric drive system is to shut down operation entirely until such time as the fault can be cleared. As will be further apparent from the following description, machine 10 can be operated in a full power mode, but when a fault occurs transitioned to a limp home mode that is less than a full power mode and may require the machine, typically within a certain period of time, to be stopped and evaluated for service.

An operator alert or alert device 36 may be positioned in cab 17. In some embodiments, when machine 10 is transitioned to a limp home mode a countdown timer can be started and notify an operator that limp home mode is enabled and display, for example, time remaining before electric drive system 16 is to be fully disabled. This capability can enable an operator to be notified that a ground fault, electrical disconnection, or other electrical problem has occurred while giving sufficient time for machine 10 to be driven to a suitable idling or service location.

Electric drive system 16 may further include motor drive electronics 22, typically including one or more inverters, that provide and condition electrical power supplied from battery bank 20 to the one or more electric drive motors 18. Electric drive system 16 further includes an accessory system 24. Accessory system 24 may include a plurality of electrically powered accessories 28, and a power distribution unit (PDU) 26. Electrically powered accessories 28 can include a variety of different accessories that control, operate, and monitor various systems and subsystems onboard machine 10. In an implementation, the plurality of electrically powered accessories 28 includes temperature control accessories to control temperatures of a variety of different onboard components and systems in machine 10 and each having an electric motor, as further discussed herein.

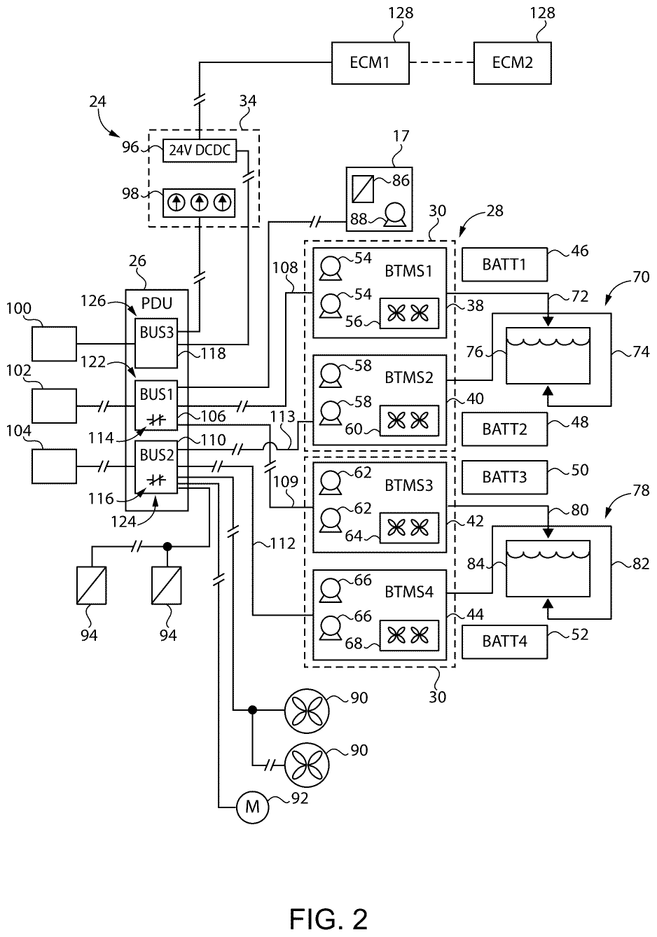

Referring also now to FIG. 2, there are shown features of accessory system 24 in further detail. Accessories 28 may be arranged in a first accessory set 30 and a second accessory set 32. In some implementations, each of first accessory set 30 and second accessory set 32 may include at least one of a pump, a compressor, or a fan. Machine 10 may include a first plurality of temperature-sensitive components temperature-controlled by first accessory set 30, and a second plurality of temperature-sensitive components temperature-controlled by the second accessory set 32. The temperature-sensitive components may include electrical energy storage devices such as batteries operable or optimally operable within a relatively narrow temperature range, for example.

First accessory set 30 may include a first battery thermal management system (BTMS1) 38 and a second battery thermal management system (BTMS2) 40. Second accessory set 32 may include a third battery thermal management system (BTMS3) 42 and a fourth battery thermal management system (BTMS4) 44. Each of BTMS 1-4 may include electrically powered accessories structured to control a temperature of one of a plurality of batteries. In the illustrated embodiment, BTMS1 includes a plurality of compressors 54 and a plurality of fans 56, structured to compress a refrigerant fluid and circulate the refrigerant fluid in heat transference contact with a first battery (BATT1) 46. BTMS2 includes compressors 58 and fans 60, BTMS3 includes compressors 62 and fans 64, and BTMS4 includes compressors 66 and fans 68. BTMS2 is associated with a second battery (BATT2) 48, BTMS3 is associated with a third battery (BATT3) 50, and BTMS4 is associated with a fourth battery (BATT4) 52. BTMS1-4 may generally be functionally similar to one another, compressing and circulating refrigerant fluid for battery cooling via the respective compressors, and cooling the refrigerant via the respective fans. Accessories 28 may also include a plurality of battery heaters 94. It should be appreciated that any arrangement and combination of components for thermal management of electrical energy storage devices or other temperature-sensitive components via at least one of cooling or heating, such as the batteries discussed herein, might be used, and FIG. 2 illustrates but one example.

Electric drive system 16 may also include a plurality of fluid circuits conveying a cooling fluid to exchange heat with refrigerant in BTMS1-4 and/or to exchange heat with BATT1-4 or potentially other fluids of components in machine 10. In the illustrated embodiment a first fluid circuit 70 includes a first fluid loop 72 and a second fluid loop 74 associated respectively, with BTMS1 and BTMS2, and a shared shunt tank 76. Cooling fluid, such as engine coolant, water, or various mixtures may be circulated in fluid circuit 70. A second fluid circuit 78 is associated with BTMS3 and BTMS4 and includes a first fluid loop 80, a second fluid loop 82, and a shared shunt tank 84. Each of first accessory set 30 and second accessory set 32 may include at least one accessory working-fluid connected to a respective one of first fluid circuit 70 and second fluid circuit 78. Working-fluid connected means an accessory acts on a working fluid such as by compression, expansion, or conveyance.

Accessories 28 may also include one or more fans 90 structured for cooling other parts of machine 10, such as power electronics in electric drive system 16, and an electrically powered blower 92.

It will be recalled that electric drive machine 10 is operable in a full power mode as well as a limp home mode. It has been observed that when full power in electric drive system 16 is not available due to a fault or other problem some power can still be provided by selectively employing parts of electric drive system 16, including some of accessories 28, that are not faulted. It has nevertheless been observed that even when full power is not available that some temperature control to some locations or components in electric drive system 16 remains desirable. The present disclosure addresses these and other concerns by selectively providing power to certain parts of electric drive system 16 such that the one or more electric drive motors 18 can still be operated without suspending temperature control of temperature-sensitive components such as batteries or others.

To this end, PDU includes a first bus 106 electrically connected to plural accessories in first accessory set 30 and to at least one accessory in second accessory set 32. PDU 26 also includes a second bus 110 electrically connected to plural accessories in second accessory set 32 and to at least one accessory in first accessory set 30. As can be seen in FIG. 2 electrical connection lines 108 connect between first bus 106 and BTMS1 providing electrical power to compressors 54 and fans 56. Electrical connection lines 109 electrically connect first bus 106 to BTMS3 providing electric power to compressors 62 and fans 64. Electrical lines 112 electrically connect second bus 110 to BTMS4 and electrical lines 113 connect second bus 110 to BTMS2.

From the foregoing description it can be appreciated that first accessory set 30 includes accessories associated with a first plurality of temperature-sensitive components, namely BATT1 and BATT2. Second accessory set 32 includes a plurality of accessories associated with BATT3 and BATT4. One fluid circuit 70 is provided that shares a cooling fluid by way of shared shunt tank 76 between BTMS1 and BTMS2. One fluid circuit 78 provides cooling fluid by way of fluid loop 80 and fluid loop 82 and shunt tank 84 associated with BATT3 and BATT4. Electrical connections of the several BTMS modules can be understood as crossover-connected relative to the functional, temperature control connections among the respective first accessory set 30 and second accessory set 32. Put differently, while the accessories in first accessory set 30 control temperatures of the same temperature-sensitive components, the individual accessories do not share the same electrical supply. Second accessory set 32 is analogously configured.

PDU 26 further includes a first contactor 114 electrically connected to first bus 106, and a second contactor 116 electrically connected to second bus 110. Electric drive machine 10 has a full power mode, as noted above, where each of first contactor 114 and second contactor 116 in PDU 26 is ON. Electric drive machine 10 is adjustable to a limp home mode where one of first contactor 114 or second contactor 116 is ON and the other of first contactor 114 or second contactor 116 is OFF. First contactor 114 and second contactor 116 may switch from an ON state where the respective bus is energized to the OFF state where the respective bus is deenergized in response to a ground fault, for example. Electric drive system 16 may also be configured by way of a high-voltage interlock loop (HVIL) to switch either of first contactor 114 or second contactor 116 OFF in scenarios other than occurrence of a ground fault, such as when a non-tooled disconnection of electrically powered components occurs. In this general way electric drive system 16 can be protected from ground faults as well as disconnections causing risk of arc flashes or other issues. “Contactors” as contemplated herein include electrical devices switchable between a first state (ON) providing an electrical connection, and a second state (OFF) at which electrical connection is interrupted. Suitable contactors may be those sold under the tradename GIGAVAC®, for example, available from Sensata Technologies.

PDU 26 may also include a third bus 118. Third bus 118 may be electrically connected to a third accessory set 34. In an implementation, third bus 118 may be electrically connected to a third accessory set 34 and not electrically connected to any accessories of first accessory set 30 and second accessory set 32. Third accessory set 34 may include water pumps 98 for circulating water or coolants to, for example, motors, brakes, batteries, or other components in machine 10, and a DC-DC converter 96, such as a 24-volt DC-DC converter. DC-DC converter 96 may be electrically connected to a plurality of electronic control modules 128 in electric drive system 16. Electronic control modules 128 might include one or more motor control modules. a transmission control module, steering, implement, or other computerized control modules. It may generally be desirable in the event of a ground fault or other electrical problem in third accessory set 34 to disable machine 10 entirely. Thus, third bus 118 may be electrically separate from all accessories other than third accessory set 34. Additional auxiliary accessories or accessory sets may be optionally electrically connected to first bus 106, second bus 110, and third bus 118, including a first auxiliary accessory 100, a second auxiliary accessory 102, and a third auxiliary accessory 104, respectively.

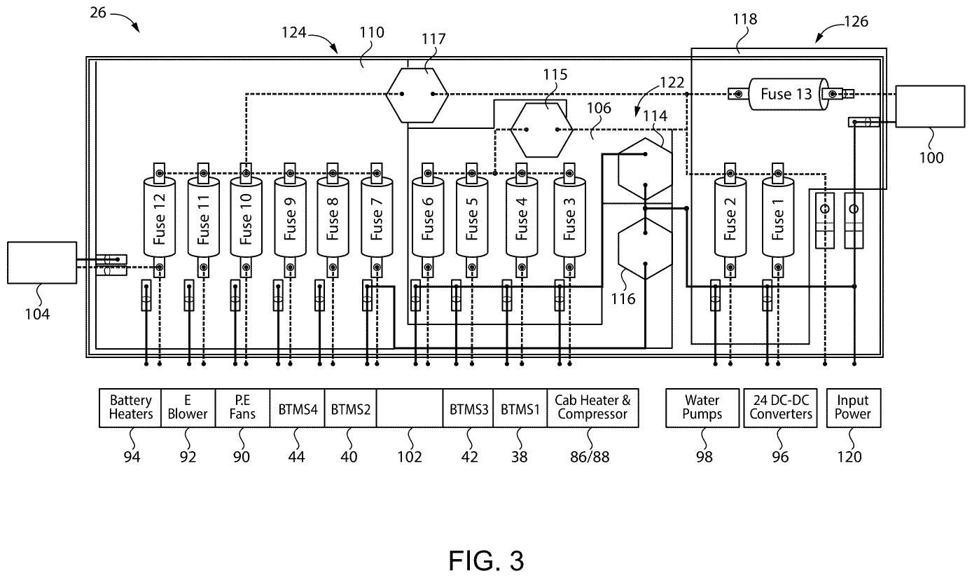

Referring also now to FIG. 3, there are shown further details of PDU 26. PDU 26 may have an input power or electric power input 120, that feeds electric power to each of first bus 106, second bus 110, and third bus 118. In the illustrated embodiment, PDU 26 includes a first switched circuitry 122 that includes first bus 106, a second switched circuitry 124 that includes second bus 110, and an unswitched circuitry 126 that includes third bus 118. First contactor 116 is connected electrically between input 120 and first bus 106. Second contactor 116 is connected electrically between input 120 and second bus 110. Additional contactors 115 and 117 may be connected electrically between first bus 106 and second bus 110, and third bus 118, respectively. First accessory set 30, including elements depicted in FIG. 3, may include plural accessories parallel-connected to first bus 106, and at least one accessory crossover-connected to second bus 110. Second accessory set 32 may include plural accessories parallel-connected to second bus 110, and at least one accessory crossover-connected to first bus 106.

From the illustrations, it can be appreciated that accessories 86, 88, BTMS1, and auxiliary accessory 102 can be understood as parallel-connected to first bus 106. BTMS3 is part of second accessory set 32 and is thus understood as crossover-connected to first bus 106. BTMS4, fans 90, electric blower 92, battery heaters 94, and auxiliary accessory 104 are parallel-connected to second bus 110, and BTMS2 is crossover-connected to second bus 110. As with operating machine 10 in a full power mode or a limp home mode, PDU 26 is operable in a full power mode where each of first contactor 114 and second contactor 116 is ON, and adjustable to operate in a limp home mode where one of first contactor 114 or second contactor 116 is ON and the other of first contactor 114 and second contactor 116 is OFF.

### INDUSTRIAL APPLICABILITY

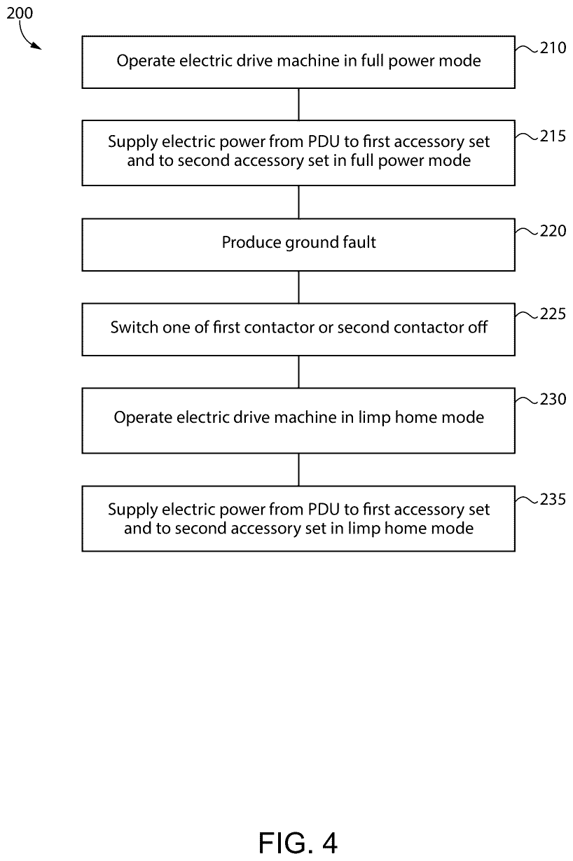

Referring to the drawings generally, but also now focusing on FIG. 4, there is shown a flowchart 200 illustrating example methodology, according to one embodiment. At a block 210 electric drive machine 10 is operated in a full power mode where each of first contactor 114 and second contactor 116 connected to first bus 106 and second bus 110, respectively, is ON. From block 210 flowchart 200 advances to a block 215 to supply electric power from PDU 26 to plural accessories in first accessory set 30 and to at least one accessory in second accessory set 32 via first bus 106, and to plural accessories in second accessory set 32 and to at least one accessory in first accessory set 30 via second bus 110 in the full power mode of electric drive machine 10. From block 215 flowchart 200 advances to a block 220 to produce a ground fault. Producing a ground fault could include an electrical short, for example.

From block 220 flowchart 200 advances to a block 225 to switch one of first contactor 114 or second contactor 116 OFF. From block 225 flowchart 200 advances to a block 230 to operate machine 10 in the limp home mode, based on switching one of the first contactor 114 or second contactor 116 OFF. Operating electric drive machine 10 in the limp home mode can also include starting a countdown timer, on or associated with operator alert 36, based on switching the one of the first contactor 114 or the second contactor 116 OFF. Electric power to electric drive system 16 can be shut down entirely based on an expiration of the countdown timer, for example, after ten minutes, twenty minutes, etc., has elapsed.

From block 230 flowchart 200 may advance to a block 235 to supply electric power from PDU 26 to first accessory set 30 and to second accessory set 32 in the limp home mode. At this point, batteries in battery bank 20 may be operating derated, such that electric drive system 16 is provided only sufficient power to operate machine 10 at a relatively slow or medium speed to reach a suitable service location. Meanwhile, because of the crossover connection of electric power between first accessory set 30 and second bus 110, or between second accessory set 32 and first bus 106, some temperature control of all of the batteries will continue. In other words, because some fluid conveyance to all of the BTMS modules continues in the limp home mode, batteries and associated components are substantially less likely to overheat.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. An electric drive machine comprising:
a frame;
ground-engaging propulsion elements coupled to the frame;
an electric drive system including at least one electric drive motor structured to operate the ground-engaging propulsion elements, a power distribution unit (PDU), and a plurality of electrically powered accessories arranged in a first accessory set and a second accessory set;
the PDU including a first bus electrically connected to plural accessories in the first accessory set and to at least one accessory in the second accessory set, a second bus electrically connected to plural accessories in the second accessory set and to at least one accessory in the first accessory set, a first contactor electrically connected to the first bus, and a second contactor electrically connected to the second bus; and
the electric drive machine having a full power mode where each of the first contactor and the second contactor in the PDU is ON, and is adjustable to a limp home mode where one of the first contactor or the second contactor is ON and the other of the first contactor or the second contactor is OFF.

2. The electric drive machine of claim 1 wherein the plurality of electrically powered accessories includes a plurality of temperature control accessories each having an electric motor.

3. The electric machine of claim 2 wherein each of the first and the second accessory set includes at least one of a pump, a compressor, or a fan

4. The electric drive machine of claim 3 further comprising a first plurality of temperature-sensitive components temperature-controlled by the first accessory set, and a second plurality of temperature-sensitive components temperature-controlled by the second accessory set.

5. The electric drive machine of claim 4 wherein each of the first and the second plurality of temperature-sensitive components includes an energy storage device.

6. The electric drive machine of claim 5 wherein each energy storage device includes a battery.

7. The electric drive machine of claim 4 further comprising a first fluid circuit and a second fluid circuit, and the first accessory set includes at least one accessory working-fluid connected to the first fluid circuit, and the second accessory set includes at least one accessory working-fluid connected to the second fluid circuit.

8. The electric drive machine of claim 7 wherein:
the first fluid circuit includes a plurality of fluid loops, and a first shared shunt tank; and
the second fluid circuit includes a plurality of fluid loops, and a second shared shunt tank.

9. The electric drive machine of claim 1 wherein the plurality of accessories includes a third accessory set, and the PDU includes a third bus electrically connected to plural accessories of the third accessory set but not electrically connected to any accessories of the first accessory set and the second accessory set.

10. The electric drive machine of claim 9 wherein the third accessory set includes a DC-DC power supply electrically connected to at least one electronic control module in the electric drive machine.

11. A method of operating an electric drive machine comprising:
operating an electric drive machine in a full power mode where each of a first contactor electrically connected to a first bus and a second contactor electrically connected to a second bus in a power distribution unit (PDU) is ON;
supplying electric power from the PDU to plural accessories in a first accessory set and to at least one accessory in a second accessory set via the first bus, and to plural accessories in the second accessory set and to at least one accessory in the first accessory set via the second bus, in the full power mode of the electric drive machine;
switching the first contactor OFF;
operating the electric drive machine in a limp home mode based on the switching the first contactor OFF; and
supplying electric power from the PDU to the plural accessories in the second accessory set and to the at least one accessory in the first accessory set via the second bus, in the limp home mode of the electric drive machine.

12. The method of claim 11 wherein each of the first and the second accessory set includes a plurality of temperature control accessories.

13. The method of claim 12 further comprising controlling temperatures of a plurality of temperature-sensitive components in each of the full power mode and the limp home mode.

14. The method of claim 13 wherein the plurality of temperature-sensitive components includes a plurality of batteries.

15. The method of claim 13 wherein the controlling temperatures further includes conveying a temperature control fluid in a fluid circuit via the at least one of the accessories of the first accessory set electrically connected to the second bus during the operating the electric drive machine in the limp home mode.

16. The method of claim 11 wherein the operating the electric drive machine in a limp home mode includes operating batteries in the electric drive machine derated.

17. The method of claim 16 further comprising starting a countdown timer based on the switching the first contactor OFF, and shutting down electric power to an electric drive motor in the electric drive machine based on an expiration of the countdown timer.

18. An electric drive system for a machine comprising:
a power distribution unit (PDU) including an electric power input, a first switched circuitry, a second switched circuitry, and an unswitched circuitry;
the first switched circuitry including a first bus and a first contactor connected electrically between the first bus and the electric power input, the second switched circuitry including a second bus and a second contactor connected electrically between the second bus and the electric power input, and the unswitched circuitry including a third bus;
a plurality of electrically powered accessories arranged in a first accessory set, and a second accessory set;
the first accessory set including plural accessories parallel-connected to the first bus, and at least one accessory crossover-connected to the second bus, and the second accessory set including plural accessories parallel-connected to the second bus, and at least one accessory crossover-connected to the second bus; and
the PDU being operable in a full power mode where each of the first contactor and the second contactor is ON, and adjustable to operate in a limp home mode where one of the first contactor or the second contactor is ON and the other of the first contactor or the second contactor is OFF.

19. The electric drive system of claim 18 further comprising a first fluid circuit and a second fluid circuit, and the first accessory set and the second accessory each include at least one accessory, respectively, working-fluid connected to the first fluid circuit and the second fluid circuit;
the first fluid circuit and the second fluid circuit each including a plurality of fluid loops each structured to convey a fluid in heat transference contact with a different one of a plurality of temperature-sensitive components; and
the first fluid circuit includes a first shunt tank shared by the respective plurality of fluid loops, and the second fluid circuit includes a second shunt tank shared by the respective plurality of fluid loops.

20. The electric drive system of claim 19 further comprising a first plurality of batteries temperature-controlled via the plurality of fluid loops of the first fluid circuit, and a second plurality of batteries temperature-controlled via the plurality of fluid loops of the second fluid circuit.
